(19) United States
(12) Patent Application Publication
(10) Pub. No.: US 2009/0244122 A1
(43) Pub. Date: Oct. 1, 2009

(54) LIQUID CONTAINER, BOARD, AND METHOD OF REWRITING LIQUID INFORMATION

(76) Inventors: Taku Ishizawa, Shiojiri-shi (JP); Satoshi Shinada, Shiojiri-shi (JP)

Correspondence Address: STROOCK & STROOCK & LAVAN LLP, 180 MAIDEN LANE, NEW YORK, NY, 10038, US

(21) Appl. No.: 12/401,365

(22) Filed: Mar. 10, 2009

(30) Foreign Application Priority Data
Mar. 13, 2008 (JP) 2008-63582
Mar. 6, 2009 (JP) 2009-53479

(51) Int. Cl. B41J 2/195; B41J 2/175

(52) U.S. Cl. 347/7; 347/86

(57) ABSTRACT

A liquid container adapted for installation in a liquid jetting device includes a container body that contains a liquid, a memory, a detector, and an information rewriting portion. The memory allows the liquid jetting device to read and write liquid information relating to the contained liquid while the liquid container is in an installed state installed in the liquid jetting device. The sensing portion detects installation of the liquid container in the liquid jetting device, or detachment of the liquid container from the liquid jetting device. The information rewriting portion rewrites the liquid information in the memory, responsive to detection of the installation or detachment.

### CROSS REFERENCE TO RELATED APPLICATIONS

This application relates to Japanese Patent Applications No. 2008-63582, filed on Mar. 13, 2008 and No. 2009-53479, filed on Mar. 6, 2009, the entire disclosure of which is incorporated by reference.

### BACKGROUND

1. Technical Field

The present invention relates to a liquid container, a board, and a method of rewriting liquid information.

2. Description of the Related Art

A typical inkjet printer is equipped with one or more ink containers containing ink. In one known technology relating to ink containers that have on-board memory for recording residual amount information indicating residual ink amount, the ink container is provided with a reset button which is pushed when the container has been refilled. According to this technology, when the reset button is pushed, the residual amount information in the memory will be rewritten so as to ensure correct operation of the printer.

However, in some cases the need for the user to press the reset button was troublesome for the user. Such problems are not limited to ink containers, but are common to liquid containers installable in liquid jetting devices.

### SUMMARY

It is accordingly one object of the present invention to provide a liquid container adapted for installation in the liquid jetting device, whereby the burden of operation on the user may be reduced.

A first aspect of the present invention provides a liquid container adapted for installation in a liquid jetting device. The liquid container according to the first aspect includes: a container body that contains a liquid; a memory adapted to allow the liquid jetting device to read and write liquid information relating to the contained liquid while the liquid container is in an installed state installed in the liquid jetting device; a sensing portion that detects installation of the liquid container in the liquid jetting device, or detachment of the liquid container from the liquid jetting device; and an information rewriting portion that rewrites the liquid information in the memory, responsive to detection of the installation or detachment. According to this mode, when the liquid container is installed or detached, liquid information stored in the memory will be rewritten independently of a write operation by the liquid jetting device, so that the user will not need to instruct that the liquid information in the memory be rewritten. As a result, the burden of operation on the user may be reduced.

With the liquid container according to the first aspect of the present invention, the information rewriting portion may rewrite the liquid information if a value of the liquid information in the memory meets a prescribed condition when the installation or detachment has been detected. With this arrangement, the number of times that liquid information is rewritten can be reduced, and memory life can be extended.

With the liquid container according to the first aspect of the present invention, the information rewriting portion may rewrite the liquid information if an update count of the liquid information in the memory by the liquid jetting device exceeds a prescribed count when the installation or detachment has been detected. With this arrangement, the number of times that liquid information is rewritten can be reduced, and memory life can be extended.

With the liquid container according to the first aspect of the present invention, the liquid information may include liquid amount information for identifying at least either one of a consumed amount and a residual amount of the contained liquid. With this arrangement, when the liquid container is installed or detached, liquid information stored in the memory will be rewritten independently of a write operation by the liquid jetting device.

With the liquid container according to the first aspect of the present invention, the liquid jetting device may rewrite consumed amount information in the memory so as to increase the consumed amount of liquid indicated by the consumed amount information, and the information rewriting portion may rewrite the consumed amount information in the memory so as to decrease the consumed amount of liquid indicated by the consumed amount information. With this arrangement, situations in which the residual amount information indicates absence of liquid can be avoided.

With the liquid container according to the first aspect of the present invention, the liquid container may be furnished with a refilling hole for refilling the liquid. With this arrangement, residual amount information for a liquid can be rewritten independently of the liquid jetting device, when the liquid has been refilled for example.

The liquid container according to the first aspect of the present invention may further includes: a memory terminal adapted to provide electrical connection of the memory and the liquid jetting device in the installed state; and a switching portion that switches a connection of the memory and the memory terminal between a state of continuity and a state of non-continuity; wherein the switching portion may place the connection of the memory and the memory terminal to a state of non-continuity while the information rewriting portion is rewriting the liquid information. With this arrangement, access to the memory by the liquid jetting device while the information rewriting portion is rewriting liquid information can be prevented more reliably.

The liquid container according to the first aspect of the present invention may further includes: a memory terminal adapted to provide electrical connection of the memory and the liquid jetting device in the installed state; and a switching portion that switches a connection of the memory and the memory terminal between a state of continuity and a state of non-continuity; wherein the switching portion may place the connection of the memory and the memory terminal to a state of non-continuity during a time interval that includes an interval in which the information rewriting portion is rewriting the liquid information. With this arrangement, access to the memory by the liquid jetting device while the information rewriting portion is rewriting the liquid information can be prevented more reliably.

With the liquid container according to the first aspect of the present invention, the sensing portion may include a photosensor. With this arrangement, detachment or installation of the liquid container can be detected easily through the use of a photosensor.

With the liquid container according to the first aspect of the present invention, the sensing portion may include a switch. With this arrangement, detachment or installation of the liquid container can be detected easily through the use of a switch.

The liquid container according to the first aspect of the present invention may further includes a power supply unit that supplies power for enabling the information rewriting portion to read from or write to the memory, while the liquid container is not installed in the liquid jetting device. With this arrangement, when the liquid container is detached, the liquid information stored in the memory can be rewritten using power supplied by the power supply unit.

A second aspect of the present invention provides a liquid container adapted for installation in a liquid jetting device. The liquid container according to the second aspect of the present invention includes: a liquid container portion that contains a liquid; and an adaptor adapted to receive detachable installation of the liquid container portion, and adapted to be installed in the liquid jetting device; wherein the adaptor includes: a memory adapted to allow the liquid jetting device to read and write liquid information relating to the liquid when the adaptor is in an installed state installed in the liquid jetting device; a sensing portion that detects installation of the liquid container portion in the adaptor or detachment of the liquid container portion from the adaptor; and an information rewriting portion that rewrites the liquid information in the memory, responsive to detection of the installation or detachment. According to this aspect, when the liquid container is installed or detached, the liquid information stored in the memory provided to the adapter will be rewritten by independently of a write operation by the liquid jetting device, so that the user will not need to instruct that the liquid information in the memory be rewritten. As a result, the burden of operation on the user may be reduced.

The invention may be reduced to practice in various different embodiments, for example, a board adapted for installation in a liquid jetting device; a board adapted for mounting on a liquid container; a method of rewriting liquid information recorded in memory, wherein the information relates to a liquid that is contained in a liquid container and supplied to a liquid jetting device; or a method of controlling the aforementioned liquid container or board.

The above and other objects, characterizing features, aspects and advantages of the present invention will be clear from the description of preferred embodiments presented below along with the attached figures.

### BRIEF DESCRIPTION OF THE DRAWINGS

FIG. 1 is an illustration depicting a general configuration of a printing system according to an embodiment of the present invention;

FIG. 2 is a perspective view depicting an external configuration of an ink cartridge in Embodiment 1;

FIG. 3 is a diagram depicting an ink cartridge, shown mounted on a carriage;

FIGS. A4 and 4B are diagrams depicting a configuration of a board;

FIG. 5 is a diagram depicting nine terminals on the front face of a board;

FIG. 6 is an illustration depicting an internal configuration of an ink cartridge;

FIG. 7 is a diagram depicting an electrical configuration of an ink cartridge and a printer of Embodiment 1;

FIG. 8 is a flowchart showing process steps of a reset process of Embodiment 1;

FIG. 9 is a diagram depicting an electrical configuration of an ink cartridge and a printer of Embodiment 2;

FIG. 10 is a flowchart showing process steps of a reset process of Embodiment 2;

FIGS. 11A and 11B are diagrams depicting a configuration of a board in Embodiment 3;

FIG. 12 is a flowchart showing process steps of a reset process of Embodiment 4;

FIG. 13 is a flowchart showing process steps of a reset process of Embodiment 5;

FIG. 14 is a first diagram depicting an internal configuration of an ink cartridge of Modified Embodiment 11; and

FIG. 15 is a second diagram depicting an internal configuration of an ink cartridge of Modified Embodiment 11.

### DETAILED DESCRIPTION OF THE PREFERRED EMBODIMENTS

### A. Embodiment 1

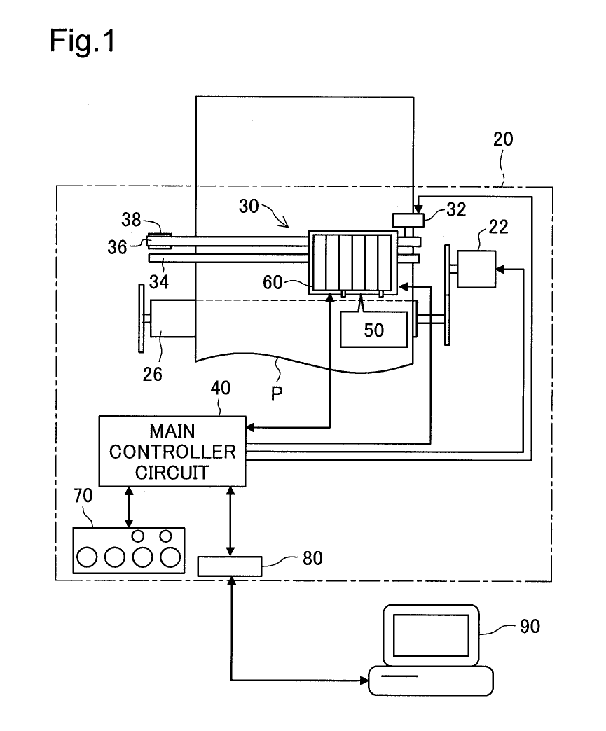

FIG. 1 is an illustration depicting a general configuration of a printing system according to an embodiment of the present invention. The printing system is furnished with a printer 20 and a computer 90. The printer 20 is connected to the computer 90 via a connector 80.

The printer 20 is furnished with a sub-scan feed mechanism, a main scan feed mechanism, a head driving mechanism, and a main controller circuit 40 for controlling these mechanisms. The sub-scan feed mechanism includes a paper feed motor 22 and a platen 26; rotation of the paper feed motor is transmitted to the platen in order to feed paper P in the sub-scanning direction. The main scan feed mechanism includes a carriage motor 32; a pulley 38; a drive belt 36 stretched between the carriage motor and the pulley; and a slide rail 34 disposed parallel to the axis of the platen 26. The slide rail 34 slidably retains a carriage 30 that is affixed to the drive belt 36. Rotation of the carriage motor 32 is transmitted to the carriage 30 via the drive belt 36 so that the carriage 30 undergoes reciprocating motion along the slide rail 34 in the axial direction of the platen 26 (main scanning direction). The head driving mechanism includes a print head unit 60 that is carried on the carriage 30, and is adapted to drive the print head and eject ink onto the paper P. The print head unit 60 can accommodate a plurality of detachably installed ink cartridges, as will be discussed later. Also on board the carriage 30 is a carriage circuit 50. The carriage circuit 50 is a circuit that cooperates with the main controller circuit 40 to carry out control relating to the ink cartridges 100, and hereinbelow will also be referred to as a “sub-controller.” The printer 20 is additionally furnished with an operation device 70 allowing the user to make various printer settings or to check the status of the printer.

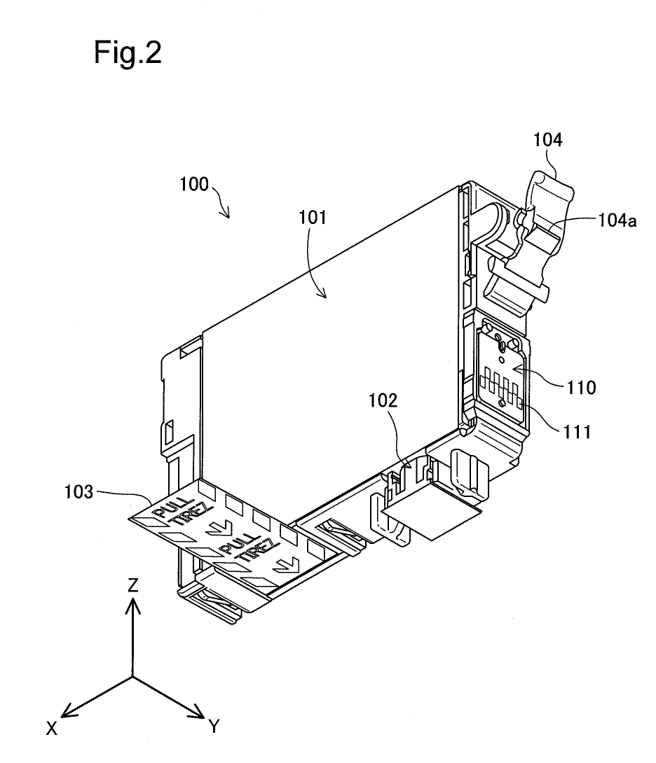

FIG. 2 is a perspective view depicting an external configuration of an ink cartridge in Embodiment 1. The ink cartridge 100 is furnished with a container body 101 containing ink; an ink delivery portion 102; a board 110; and a locking lever 104. In FIG. 2, film 103 is a film for sealing off an outside air vent hole, and is intended to be peeled off when the ink cartridge 100 is placed in service. The ink delivery portion 102 is provided on the bottom face of the container body 101, and is adapted to deliver ink to the print head unit 60 when installed in the print head unit 60.

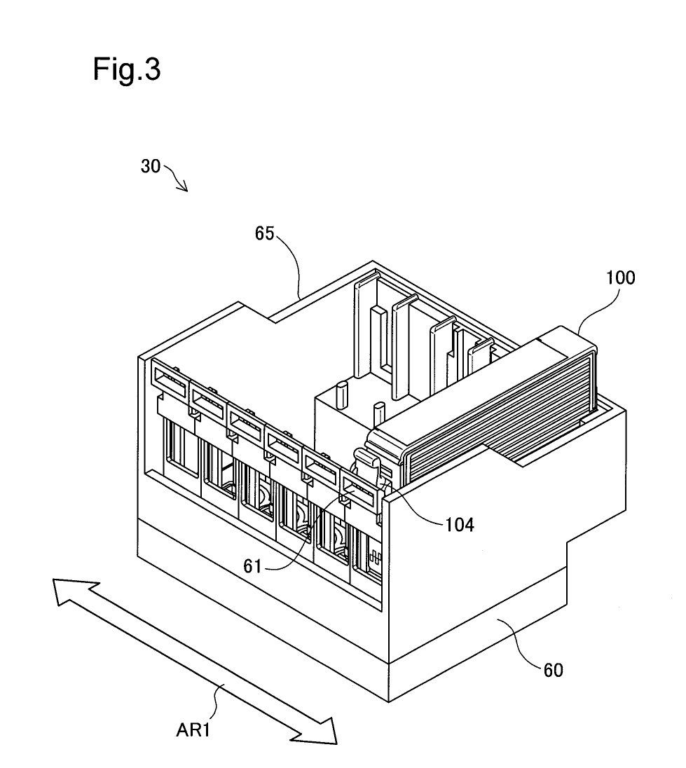

FIG. 3 is a diagram depicting an ink cartridge, shown mounted on a carriage. In the carriage 30, a holder 65 is disposed on top of the print head unit 60; the ink cartridges 100 install in this holder 65. Once an ink cartridge 100 has been installed in the holder 65, a projection 104a on the locking lever 104 will engage a recess 61 that has been formed on the holder 65. The ink cartridge 100 will thereby be secured in the holder 65. When the printer 20 is carrying out printing, the ink cartridge 100 will undergo reciprocating motion in the direction indicated by arrow AR1.

FIG. 4 depicts a configuration of the board 110. Nine terminals 111 are arranged on the front face of the board 110. A controller 130 and a memory 140 are arranged on the back face of the board 110. The controller 130 is composed of a logic circuit, for example. The controller 130 and the memory 140 are electrically connected, allowing the controller 130 to execute control processes of the memory 140, including writing of data to the memory 140 and reading of data from the memory 140. Specifically, it will execute a reset process (discussed later) for example. The memory 140 is a rewritable nonvolatile memory, such as EEPROM (Electronically Erasable and Programmable Read Only Memory) or FeRAM (Ferroelectric Random Access Memory) for example. The controller 130 and the memory 140 may be respectively constituted as different chips which are connected by lines; or constituted as a single chip.

The board 110 is additionally provided with a photosensor 120. The photosensor is a reflection type photosensor that includes a light emitting element such as an LED (Light Emitting Diode), and a photoreceptor element such as a photodiode. The photosensor is adapted to direct light from the light emitting element onto an object for sensing, and to receive the reflected light with the photoreceptor. In the present embodiment, the photosensor 120 is used to sense whether the board 110 is in an installed state in which it is installed in the holder 65 (of the printer 20), or in a noninstalled state in which it is not installed in the holder 65.

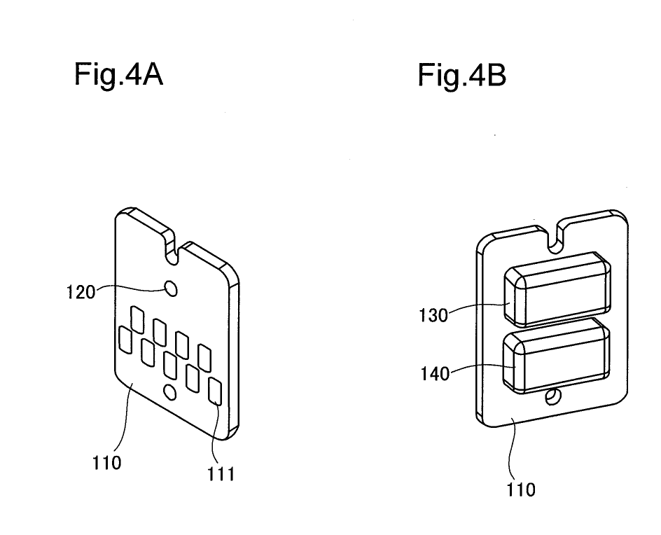

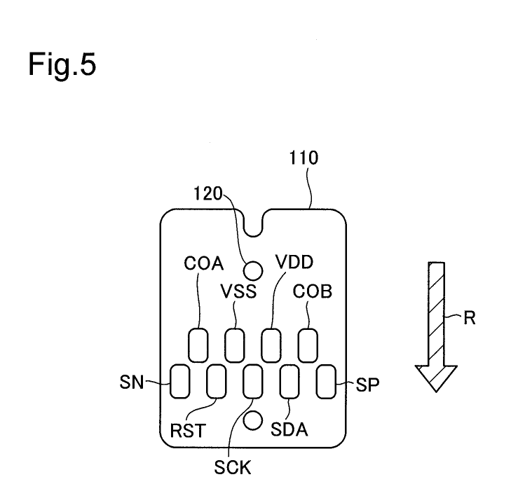

FIG. 5 is a diagram depicting the nine terminals 111 on the front face of the board 110. The terminals are generally oblong in shape and arranged to form two rows generally perpendicular to the insertion direction R. The insertion direction R indicates the direction of insertion of the ink cartridge 100 when installed in the holder 65. Of the two rows, the row lying towards the insertion direction R, i.e. towards lower side in FIG. 5, will be termed the lower row; and the row lying to the opposite side from the insertion direction R, i.e. towards upper side in FIG. 5, will be termed the upper row. The terminals that make up the upper row and the terminals that make up the lower row are arranged differently from one another such that they make a staggered arrangement and that any terminal centers do not line up with one another in the insertion direction R.

Of the terminals 111, the terminals arrayed to form the upper row are, in order from the left side, a first cartridge out terminal COA, a ground terminal VSS, a power supply terminal VDD, and a second cartridge out terminal COB. The terminals arrayed to form the lower row are, in order from the left side, a first sensor driving terminal SN, a reset terminal RST, a clock terminal SCK, a data terminal SDA, and a second sensor driving terminal SP. The electrical configuration of the terminals will be discussed later.

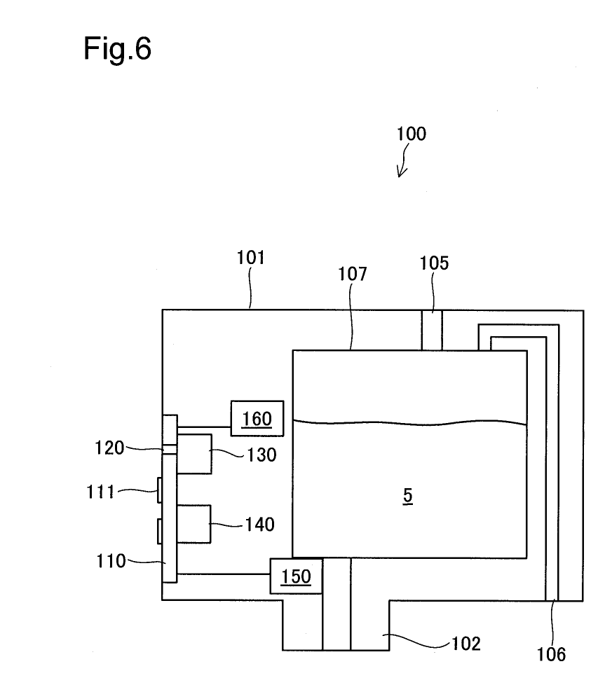

FIG. 6 is an illustration depicting the internal configuration of the ink cartridge 100. In the interior of the container body 101 of the ink cartridge 100 there are formed an ink containing chamber 107, a refilling hole 105, and an outside air vent hole 106. The ink containing chamber 107 contains ink 5. The refilling hole 105 communicates at one end with the ink containing chamber 107 and at the other opens to the outside. The opening of the refilling hole 105 is located on the top face of the ink cartridge 100. The refilling hole 105 is a hole enabling the user to refill the ink containing chamber 107 with ink after the amount of ink 5 in the ink containing chamber 107 has dropped due to consumption by the printer 20. The outside air vent hole 106 communicates at one end with the ink containing chamber 107 and at the other opens to the outside. As will be appreciated from the fact that the film 103 that seals off the opening of the outside air vent hole 106 has been adhered to the bottom face (FIG. 2), the hole is actually situated on the bottom face of the ink cartridge 100; however, in FIG. 6 it is depicted in simplified form. The outside air vent hole 106 is adapted to draw in outside air to the ink containing chamber 107 as the ink 5 in the ink containing chamber 107 is consumed.

Also provided inside the ink cartridge 100 are a sensor 150 disposed in proximity to the ink delivery portion 102; and a power supply unit 160. While not discussed in detail here, the sensor 150 includes a cavity that defines part of an ink flow channel in proximity to the ink delivery portion; an oscillating plate the defines part of the wall of the cavity; and a piezoelectric element that is situated on the oscillating plate. By supplying electrical energy to the piezoelectric element, the printer 20 can cause the oscillating plate to oscillate through the agency of the piezoelectric element. Then, by sensing characteristics (frequency, etc.) of residual vibration of the oscillating plate via the piezoelectric element, the printer 20 can sense whether ink in present in the cavity. Specifically, when conditions inside the cavity change from a condition of being filled with ink 5 to a condition of being filled with air due to the ink 5 contained in the container body 101 being consumed, the characteristics of residual vibration of the oscillating plate will change. By sensing this change in vibration characteristics via the sensor 150 (piezoelectric element), the inkjet printer can sense whether ink is present in the cavity.

As will be discussed later, the power supply unit 160 is used to supply power for operating the controller 130 and the photosensor 120 when the ink cartridge 100 (11) is in the noninstalled state having been detached from the printer 20. When the ink cartridge 100 is installed in the printer 20 (in the installed state), power for operating the controller 130 and the photosensor 120 will be supplied from the printer 20 via the power supply terminal VDD. The power supply unit 160 may include a capacitor, for example. In the installed state, this capacitor will be charged using power supplied via the power supply terminal VDD; and upon transition from the installed state to the noninstalled state, i.e. when the ink cartridge 100 has been detached from the printer 20, it will supply this accumulated charge as driving power to the photosensor 120 and to the controller 130. The power supply unit 160 may also be a UPS (Uninterruptible Power System) that include a backup battery or generator.

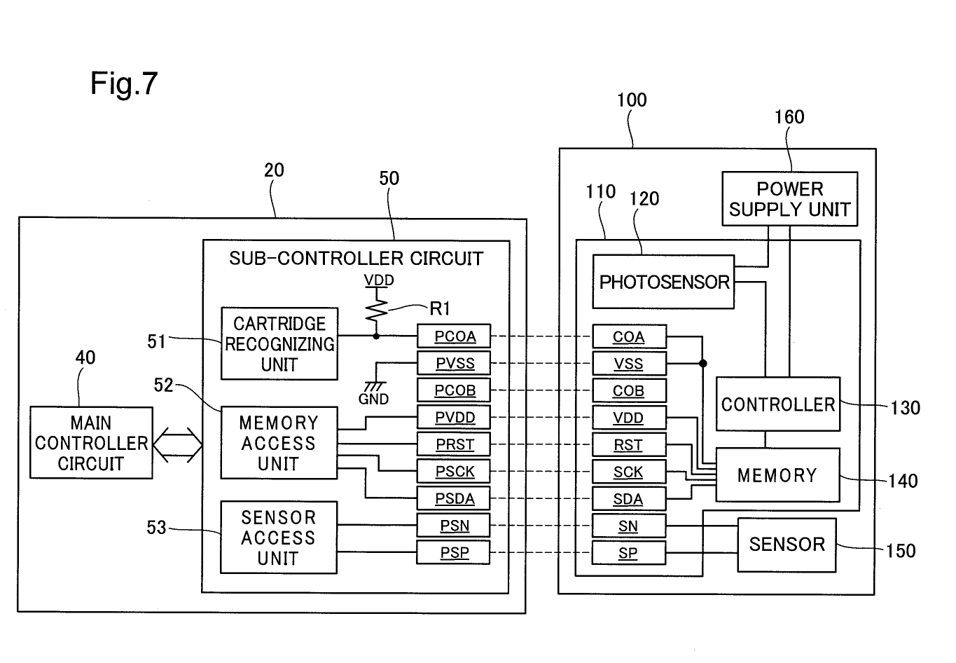

FIG. 7 is a diagram depicting an electrical configuration of the ink cartridge 100 and the printer 20 of Embodiment 1. Five terminals, i.e. the ground terminal VSS, the power supply terminal VDD, the reset terminal RST, the clock terminal CSK, and the data terminal SDA, are respectively connected to the memory 140. The two terminals situated at the opposite ends of the lower row, namely, the first sensor driving terminal SN and the second sensor driving terminal SP, are respectively connected to one electrode and the other electrode of the piezoelectric element of the sensor 150. The first cartridge out terminal COA is connected to the ground terminal VSS. In the present embodiment, the second cartridge out terminal COB is not connected to anything.

The photosensor 120 is communicably connected to the controller 130, and is used by the controller 130 to determine whether the board 110 (or the ink cartridge 100) is in the installed state or the noninstalled state with respect to the printer 20. When the ink cartridge 100 has been detached from the holder 65, the power supply unit 160 will supply driving power to the photosensor 120 and the controller 130 for a brief interval so that a reset process, discussed later, may take place.

In the printer 20, the sub-controller 50 is able to communicate with the main controller circuit 40 via a bus. The sub-controller 50 is furnished with printer-side terminals, a cartridge recognizing unit 51, a memory access unit 51, and a sensor access unit 53.

Nine printer-side terminals are provided for each single ink cartridge 100. With the ink cartridge 100 installed in the printer 20, the nine printer-side terminals will respectively contact the nine terminals of the board 110 of the ink cartridge 100 (FIG. 5). The respective ink cartridges 100 will thereby be electrically connected to the printer 20. In the following description, printer-side terminals corresponding to, or intended for contact with, terminals on the board 110 will be denoted by putting a letter P in front of the symbols for the corresponding terminal of the board 110. For example, the printer-side terminal corresponding to, or contacting, the clock terminal SCK of the board 110 will be denoted as printer-side terminal PSCK.

The printer-side ground terminal PVSS is connected to L level (GND level). The first printer-side cartridge out terminal PCOA is connected to H level (VDD level) via a pull-up resistor R1. Where GND level is O V, VDD level will be 3.3 V, for example.

Based on the potential of the first printer-side cartridge out terminal PCOA, the cartridge recognizing unit 51 will determine whether the ink cartridge 100 is currently installed in the printer 20. If the first printer-side cartridge out terminal PCOA is H level, the cartridge recognizing unit 51 will determine that a noninstalled state exists, meaning that no ink cartridge 100 is currently installed. If the PCOA is L level, the cartridge recognizing unit 51 will determine that there exists an installed state, meaning that the ink cartridge 100 is currently installed.

The printer-side power supply terminal PVDD, the printer-side reset terminal PRST, the printer-side clock terminal PSCK, and the printer-side data terminal PSDA are connected to the memory access unit 52. With the ink cartridge 100 in the installed state, the memory access unit 52 will be able to access the memory 140 of the ink cartridge 100 via these terminals. Specifically, the memory access unit 52 will be able to read residual ink amount information from the memory 140, and to write residual ink amount information to the memory 140. Residual ink amount information is a value that indicates the amount of remaining ink 5 contained in the container body 101. The initial value of residual ink amount information will correspond to the amount of ink 5 contained in the container body 101 when shipped from the factory. The main controller circuit 40 of the printer 20 monitors the residual ink amount in the ink cartridges 100. For example, at the outset of printing, the main controller circuit 40 will read out residual ink amount information from the memory 140 to ascertain the residual ink amount; and upon completion of printing will calculate the residual ink amount based on the amount of ink consumed, and update the residual ink amount information in the memory 140. That is, the main controller circuit 40 will decrement the residual ink amount information in the memory 140, as the ink is consumed. Once the residual ink amount has fallen below a prescribed value, the main controller circuit 40 will prompt the user to replace or refill the ink cartridge 100.

The first printer-side sensor driving terminal PSN and the second printer-side sensor driving terminal PSP are connected to the sensor access unit 53. With the ink cartridge 100 in the installed state the sensor access unit 53, via these terminals, will be able to operate the sensor 150 as described above and determine whether ink is present. If it is determined from the sensor result of the sensor 150 that the ink is at or below the prescribed value, the printer 20 will carry out a process to change the residual ink amount recorded in the memory to a prescribed value, for example.

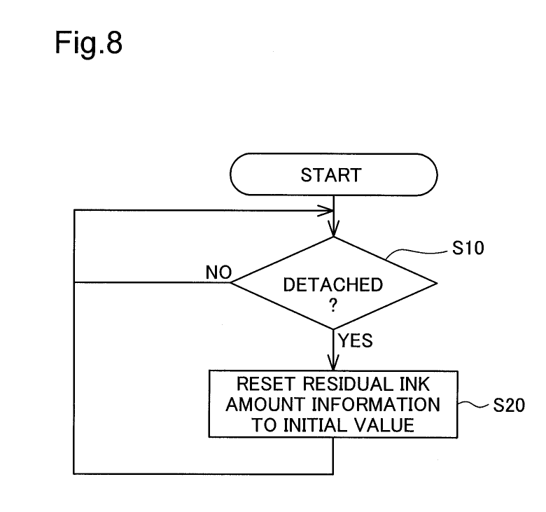

FIG. 8 is a flowchart showing process steps of the reset process in Embodiment 1. The reset process of Embodiment 1 is a process that is carried out when the ink cartridge 100 has been detached from the holder 65 of the printer 20. Detachment of the ink cartridge 100 will be sensed by the photosensor 120 which has been provided on the board 110. When the ink cartridge 100 is detached (Step S10: YES), the controller 130 will recognize through a notification from the photosensor 120 that the ink cartridge 100 has been detached, and will change the residual ink amount information in the memory 140 to the initial value (Step S20). This change of residual ink amount information will take place independently of access by the printer 20.

As will be understood from the preceding description, in the present embodiment, the photosensor 120 corresponds to the sensing portion in the claims. Also, in the present embodiment, the controller 130 corresponds to the information rewriting portion in the claims.

According to Embodiment 1 described above, when the user detaches the ink cartridge 100 from the holder 65, the residual ink amount information will be reset to its initial value. Thus, when the user has refilled the detached ink cartridge with ink 5 and then reinstalled it in the printer 20 for example, the discrepancy between the residual ink amount information and the amount of ink actually contained in the container body 101 will be eliminated. As a result, misoperation of the printer 20 can be avoided, without the need for the user to perform any operation in order to reset the residual ink amount information to its initial value.

### Embodiment 2

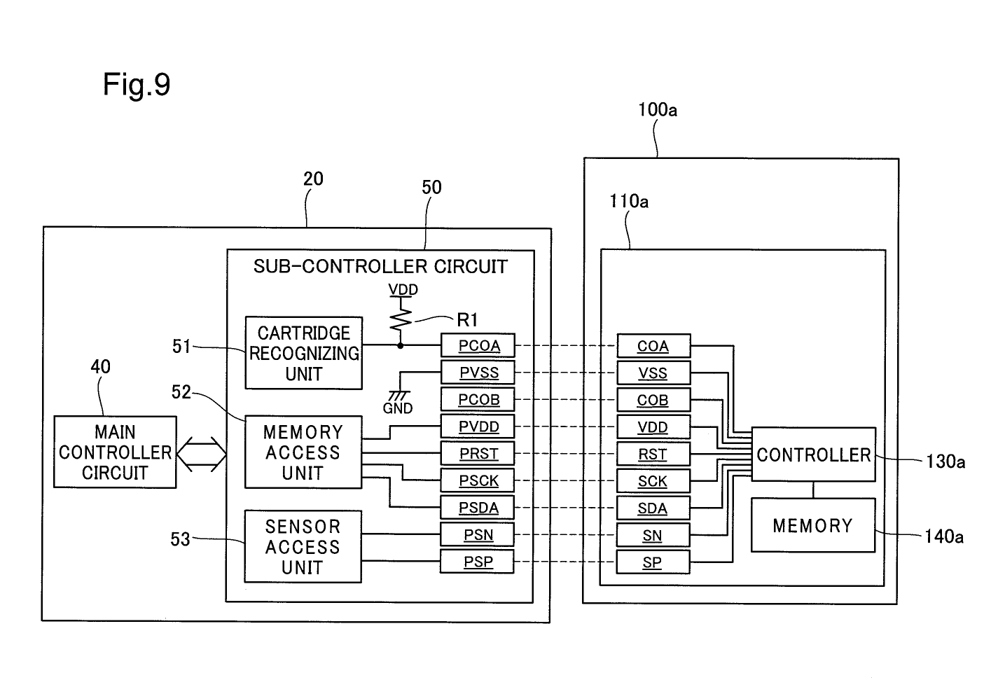

FIG. 9 is a diagram depicting an electrical configuration of an ink cartridge 100a and a printer 20 of Embodiment 2. The configuration of the printer 20 is identical to that in Embodiment 1 and will not be described here. The ink cartridge 100a of Embodiment 2 differs from that of Embodiment 1 in that it lacks the photosensor 120 and the power supply unit 160. Also, in the ink cartridge 100a of Embodiment 2, all nine of the terminals are connected to a controller 130a which is a logic circuit. In Embodiment 2, a sensor driving signal that the sensor access unit 53 has input via the sensor driving terminals SN, SP will be received by the controller 130a, which will always return a response signal indicating that ink 5 is present in the container body 101. Additionally, in Embodiment 2, the controller 130a is furnished with a timer function adapted to measure a prescribed time interval.

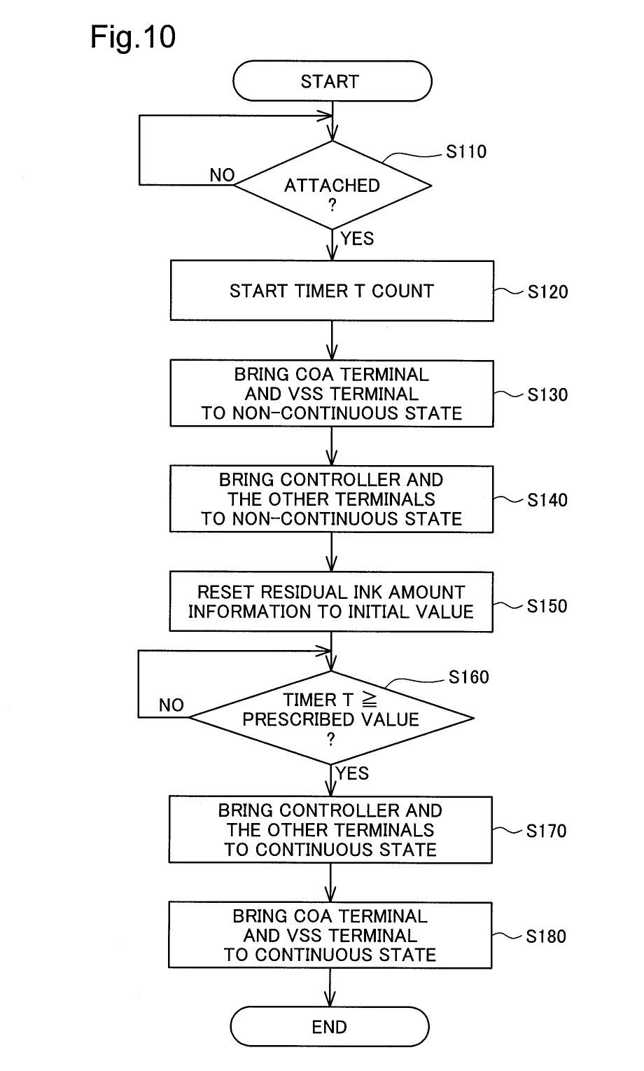

FIG. 10 is a flowchart showing process steps of the reset process in Embodiment 2. The reset process of Embodiment 2 is a process that is carried out when the ink cartridge 100a has been installed in the printer 20. Installation of an ink cartridge 100 will be recognized by the controller 130 when the power supply terminal VDD of the board 110 comes into contact with the printer-side power supply terminal PVDD of the printer 20 so that power is supplied to the controller 130 via the power supply terminal VD. For example, when the controller 130 starts up using power supplied via the power supply terminal VDD, the controller 130 may then execute the following reset process on the assumption that the ink cartridge 100 has been installed in the printer 20. When the ink cartridge 100 is installed in the printer 20 (Step S110: YES), the controller 130a will initiate a count by a timer T (Step S120). In Step S130, the controller 130a will place the first cartridge out terminal COA and the ground terminal VSS in a state of non-continuity. Specifically, the first cartridge out terminal COA and the ground terminal VSS will be placed in a state of non-continuity by a switch composed of a transistor inside the controller 130a. In Step S140, the controller 130a will produce a state of non-continuity between the controller 130a and the other seven terminals, except for the first cartridge out terminal COA and the ground terminal VSS. In Step S150, the controller 130a will rewrite the residual ink amount information in the memory 140a to the initial value. In Step S160, the controller 130a will decide if the timer T has reached a prescribed value or more. The prescribed value will be a value that corresponds to a time interval longer than the interval needed for the memory 140a to assume a state enabling it to handle subsequent access, for example. If it is determined that that the time T has not yet reached the prescribed value (Step S160: NO), the controller 130a will wait. If it is determined that that the time T has reached the prescribed value or more (Step S160: YES), the controller 130a will restore a state of continuity between the controller 130a and the other seven terminals mentioned above (Step S170). In Step S180, the controller 130a will restore a state of continuity between the first cartridge out terminal COA and the ground terminal VSS, and terminate the reset process.

Here, if the ink cartridge 100 is in the installed state, provided that there is continuity between the first printer-side cartridge out terminal PCOA and the ground terminal VSS, the first printer-side cartridge out terminal PCOA will be held at L level, and it will be correctly determined that the installed state exists. This is due to the fact that, in the ink cartridge 100, the first printer-side cartridge out terminal PCOA has continuity with the printer-side ground terminal PVSS via the first cartridge out terminal COA and the ground terminal VSS.

On other hand, even with the ink cartridge 100 in the installed condition, if the first cartridge out terminal COA and the ground terminal VSS are in a state of non-continuity, the first printer-side cartridge out terminal PCOA will be held at H level, and it will be determined that the noninstalled state exists. This is due to the fact that, since the first printer-side cartridge out terminal PCOA is held in a high-impedance state, the first printer-side cartridge out terminal PCOA is held at the potential of the power supply (H level) that is connected to it via the pull-up resistor R1.

As will be understood from the preceding description, in the present embodiment, the controller 130a corresponds to both the sensing portion and the information rewriting portion in the claims.

According to Embodiment 2 described above, when the user installs the ink cartridge 100 in the holder 65, the residual ink amount information will be reset to its initial value. Thus, when the user has refilled the detached ink cartridge with ink 5 and then reinstalled it in the printer 20 for example, the discrepancy between the residual ink amount information and the amount of ink actually contained in the container body 101 will be eliminated. As a result, misoperation of the printer 20 can be avoided, without the need for the user to perform any operation in order to reset the residual ink amount information to its initial value.

Additionally, when the residual ink amount information in the memory 140a is being rewritten to the initial value in the reset process, the first cartridge out terminal COA and the ground terminal VSS will be placed in a state of non-continuity. Thus, during the interval that residual ink amount information is being rewritten, the printer 20 will determine that the ink cartridge 100a is not installed (in the noninstalled state). As a result, problems such as data corruption arising when the printer 20 erroneously attempts to access the memory 140a while the residual ink amount information is being rewritten can be avoided.

Further, in Embodiment 2, when the residual ink amount information in the memory 140a is reset to the initial value, the seven terminals by which the printer 20 accesses the memory and the sensor will be cut off (placed in a state of non-continuity) from the controller 130a. Thus, problems such as data corruption arising when the printer 20 erroneously attempts to access the memory 140a while the residual ink amount information is being reset to the initial value can be avoided more reliably.

### C. Embodiment 3

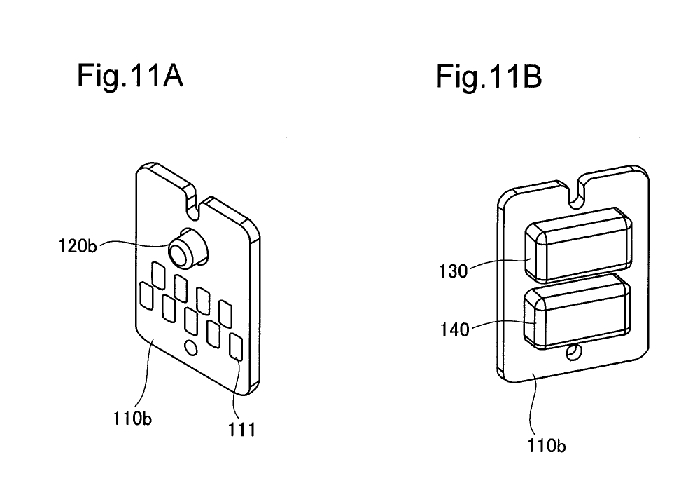

FIG. 11 is a diagram depicting the external configuration of a board 110b of Embodiment 3. The board 110 in Embodiment 3 is provided with a mechanical switch 120b in place of the photosensor 120 of the board 110 in Embodiment 1. In the installed state the mechanical switch 120b will be depressed by the holder 65; whereas in the noninstalled state is it not depressed. As a result, detachment of the ink cartridge 100 from the holder can be detected in a manner analogous to the photosensor 120. Other arrangements and operation of Embodiment 3 are the same as in Embodiment 1 and will not be described.

As will be understood from the preceding description, in the present embodiment, the mechanical switch 120b corresponds to the sensing portion in the claims. In the present embodiment, the controller 130a corresponds to the information rewriting portion in the claims.

Embodiment 3 described above affords advantages comparable to those of Embodiment 1.

### D. Embodiment 4

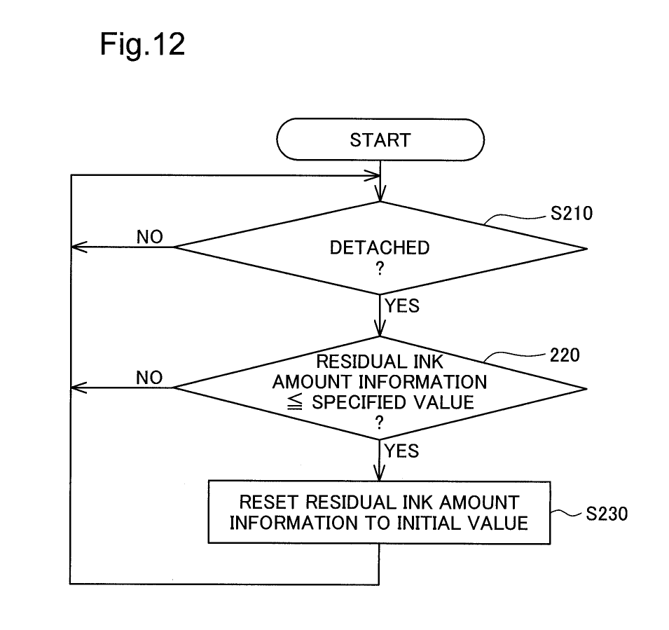

FIG. 12 is a flowchart showing process steps of a reset process of Embodiment 4. The configuration of Embodiment 4 is the same as that of Embodiment 1 depicted in FIGS. 1 to 7, so it will not be discussed here; the following description employs the same symbols used in Embodiment 1.

The reset process of Embodiment 4 is a process that is carried out when the ink cartridge 100 has been detached from the holder 65 of the printer 20. When the ink cartridge 100 is detached (Step S210: YES), the controller 130 will recognize through a notification from the photosensor 120 that the ink cartridge 100 has been detached, and will then determine whether the residual ink amount information is equal to or less than a specified value (Step S220). If the residual ink amount information exceeds a specified value (Step S220: NO), i.e. where the residual ink amount information shows that “the amount of ink 5 contained in the container body 101 exceeds a prescribed amount,” the controller 130 will do nothing. On the other hand, if the residual ink amount information is equal to or less than the specified value (Step S220: YES), i.e. where the residual ink amount information shows that “the amount of ink 5 contained in the container body 101 is equal to or less than a prescribed amount,” the controller 130 will rewrite the residual ink amount information in the memory 140 to the initial value (Step S230), and terminate the reset process.

Embodiment 4 described above affords advantages comparable to those of Embodiment 1. Also, besides the condition that the ink cartridge 100 has been detached, an additional condition for carrying out the reset operation is that the residual ink amount information is equal to or less than a specified value. Thus, unnecessary resets can be reduced, and the number of times that the memory is rewritten can be limited, reducing wear on the memory.

### E. Embodiment 5

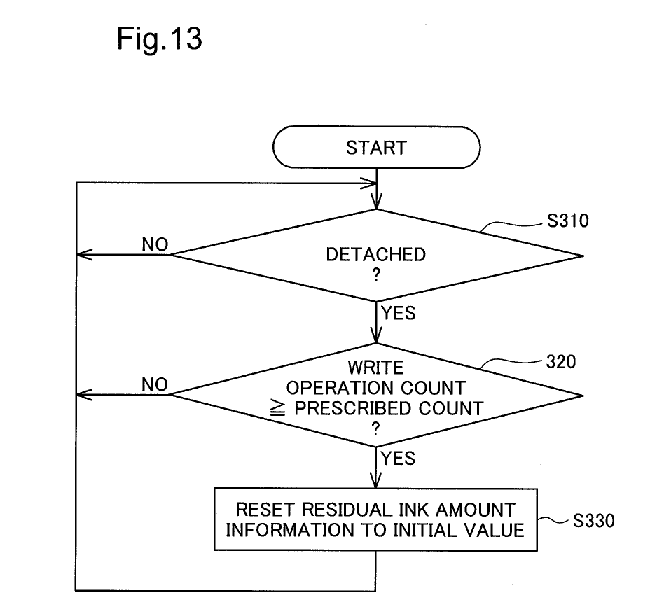

FIG. 13 is a flowchart showing process steps of a reset process of Embodiment 5. The configuration of Embodiment 5 is the same as that of Embodiment 1 depicted in FIGS. 1 to 7, so it will not be discussed here; the following description employs the same symbols used in Embodiment 1. The reset process of Embodiment 5 is a process that is carried out when the ink cartridge 100 has been detached from the holder 65 of the printer 20. When the ink cartridge 100 is detached (Step S310: YES), the controller 130 will recognize through a notification from the photosensor 120 that the ink cartridge 100 has been detached, and will then determine whether a write operation count, or the number of times that the residual ink amount information was updated by the printer 20, exceeds a prescribed number of times (Step S320). This write operation count may be stored in the memory 140 in a different area from the area where residual ink amount information is stored. If the residual ink amount information write operation count is less than the prescribed number of times (Step S320: NO), the controller 130c will do nothing. On the other hand, if the residual ink amount information write operation count is equal to or more than the prescribed number of times (Step S320: YES), the controller 130 will rewrite the residual ink amount information in the memory 140 to the initial value (Step S330), and terminate the reset process.

Embodiment 5 described above affords advantages comparable to those of Embodiment 4.

### F. Modified Embodiments

### Modified Embodiment 1

In the reset processes of the preceding embodiments, the value of the residual ink amount information is reset to its initial value; however, it may instead be changed to a value equivalent to approximately half the residual ink amount when shipped from the factory, or changed to some other value equivalent to a residual amount increased by a prescribed amount. In general, it is acceptable to change the value to any prescribed value that represents the presence of a certain amount of ink.

### Modified Embodiment 2

In the reset processes of the preceding embodiments, a value of residual ink amount information is rewritten; however, a value of consumed ink amount information may be rewritten instead. In this case, the value of the consumed ink amount information may be reset to its initial value when the ink cartridge 100 has been installed or detached, for example. The present invention is not limited to implementation in a reset process, and is applicable generally to all manner of processes in which ink information relating to ink is rewritten independently of access by the printer 20.

### Modified Embodiment 3

In the preceding Embodiment 2, by bringing about a state of non-continuity between the first cartridge out terminal COA and the ground terminal VSS, the printer 20 will be caused to make a determination that a noninstalled state exists, despite the fact that an installed state exists. However, in an alternative arrangement, in the installed state, some kind of installation communicating signal may be sent periodically from the controller of the ink cartridge to provide notification of the installed state, and the printer 20 may be caused to make a determination that a noninstalled state exists by interruption of this installation communicating signal. Generally speaking, it is acceptable to have means for notifying the printer 20 of the installed state and means for notifying of the non-installed state, even when the ink cartridge is actually in the installed state. In preferred practice, these means will be alternatively and exclusively switchable between a state in which the printer 20 is caused to make a determination that an installed state exists, and a state in which the printer 20 is caused to make a determination that a noninstalled state exists.

### Modified Embodiment 4

In the preceding embodiments, resetting of the residual ink amount information takes place immediately after the ink cartridge 100 is detached from the printer 20, or immediately after it is installed in the printer 20; however, resetting of the residual ink amount information may instead take place after a prescribed time interval (e.g. one second) has passed since the ink cartridge 100 was detached or installed, for example. In general, it is acceptable for resetting of the residual ink amount information, once triggered by detachment or installation of the ink cartridge 100, to take place at some subsequent point in time.

### Modified Embodiment 5

In Embodiment 4 above, the residual ink amount information is rewritten, for example, if the residual ink amount information is equal to or less than a prescribed value when the ink cartridge 100 has been detached; however, it would be acceptable to instead rewrite the residual ink amount information if the residual ink amount information is equal to or less than a prescribed value when the ink cartridge 100 is installed. Similarly, in Embodiment 5 above, the residual ink amount information is rewritten, for example, if the residual ink amount information write operation count has reached a value equal to or greater than a prescribed count when the ink cartridge 100 has been detached; however, it would be acceptable to instead rewrite the residual ink amount information if the residual ink amount information write operation count has reached a value equal to or greater than a prescribed count when the ink cartridge 100 is installed. The condition that must be met in addition to detachment or installation of the ink cartridge 100 may also be some other condition. For example, the ink cartridge may be provided with a weight sensor for measuring cartridge weight, with the other condition being that the weight has reached a prescribed value or less.

### Modified Embodiment 6

In the preceding Embodiment 1, a sensor 150 that employs a piezoelectric element is used, but it would be possible to instead employ an oscillator device such as an oscillator circuit designed to constantly return a response signal of a frequency indicating that ink is present; or to employ a processor such as a CPU or ASIC, or a simpler IC, to carry out exchanges with the sub-controller 50.

### Modified Embodiment 7

In the preceding embodiments, a single ink tank makes up a single ink cartridge, but instead a plurality of ink tanks may make up a single ink cartridge.

### Modified Embodiment 8

While the preceding embodiments employ a printer and ink cartridges of inkjet format, it would also be acceptable to employ a liquid jetting device adapted to jet or eject a liquid other than ink, and a liquid container containing such a liquid. Herein, the term liquid is used to include liquid-like matter containing particles of a functional material dispersed in a medium; or fluid-like matter of gel form. For example, there may be employed liquid jetting devices adapted to jet liquids that contain an electrode material, coloring matter, or other matter in dispersed or dissolved form used in the manufacture of liquid crystal displays, EL (electroluminescence) displays, field emission displays, or color filters; liquid jetting devices adapted to jet bioorganic substances used in biochip manufacture; or liquid jetting devices adapted to jet liquids as specimens used as precision pipettes. Additional examples are liquid jetting devices for pinpoint jetting of lubricants into precision instruments such as clocks or cameras; liquid jetting devices adapted to jet a solution of an ultraviolet-curing resin or other transparent resin onto a substrate for the purpose of forming a micro semi-spherical lens (optical lens) for use in optical communication elements etc.; or liquid jetting devices adapted to jet an acid or alkali etchant solution for etching circuit boards, etc. The present invention can be implemented in any of the above types of jetting devices and liquid containers for these liquids.

### Modified Embodiment 9

Some of the arrangements that have been implemented through hardware in the preceding embodiments may instead be implemented through software, and conversely some of the arrangements that have been implemented through software may instead be implemented through hardware.

### Modified Embodiment 10

In the reset processes of the preceding embodiments, a value of the residual ink amount information is rewritten; however, a value of other liquid information stored in the memory 140 may be rewritten in addition to the residual ink amount information or in place of the residual ink amount information. For example, various kinds of liquid information stored in the memory 140 may be rewritten so that after a reset process the printer 20 will recognize that a new ink relay cartridge 100 has been installed. Specific examples would be where the memory 140 records usage history information that is incremented each time that the printer 20 executes printing, or unique ID information for each ink relay cartridge 100. In this case, during the reset process the controller 130 may rewrite the usage history information to the initial value, or rewrite the ID information to a different value, for example.

### Modified Embodiment 11

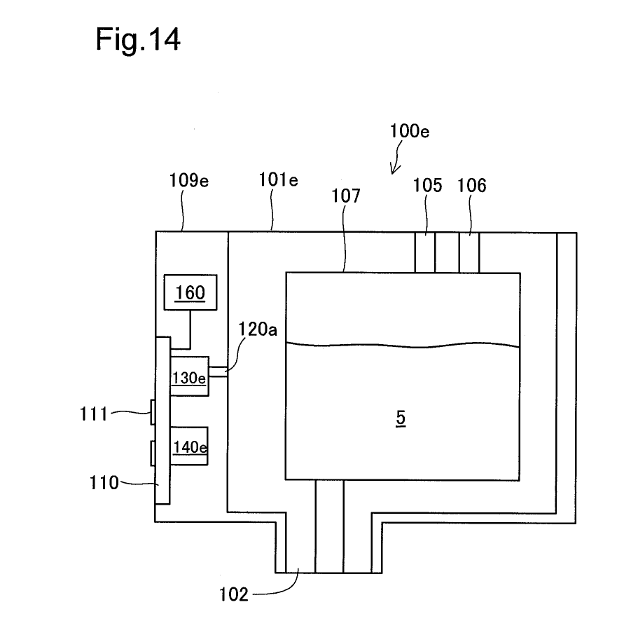

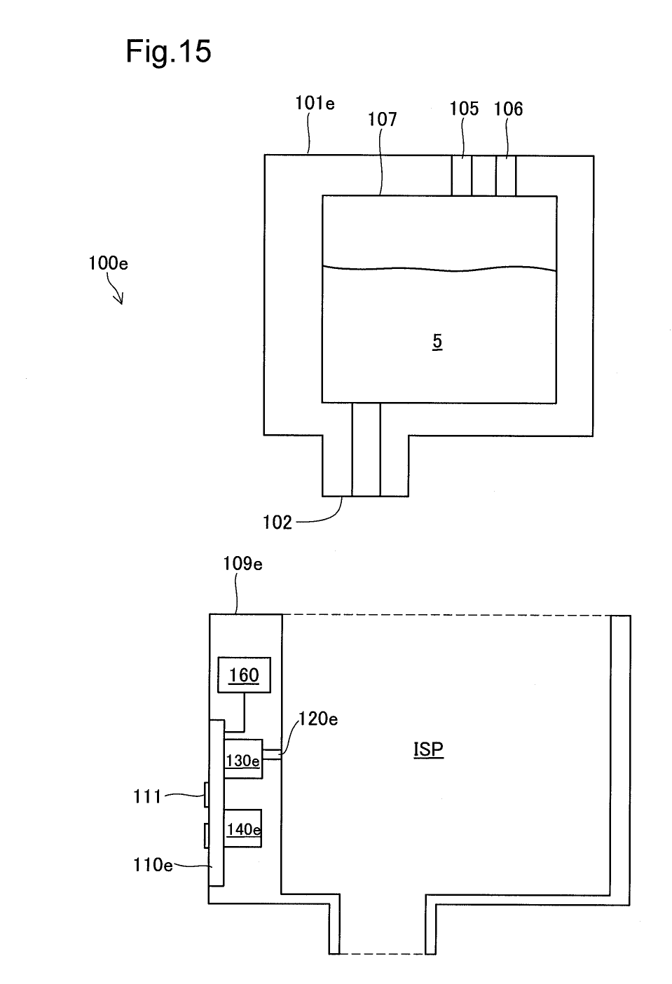

FIGS. 14 and 15 are diagrams depicting an internal configuration of an ink cartridge in Modified Embodiment 11. The ink cartridge 100e of Modified Embodiment 11 is furnished with an ink container 101e and an adaptor 109e. As depicted in FIG. 15, the ink container 101e and the adaptor 109e can be separated manually by the user. For example, the user will detach the ink container 101e from the adaptor 109e, and after filling the ink container 101e with ink 5, will reinstall the ink container 101e in an insertion space ISP of the adapter 109e. FIG. 14 depicts the ink container 101e and the adaptor 109e in the unified state, with the ink container 101e installed in the insertion space ISP of the adapter 109e. The adaptor 109e will then be installed in the holder 65 of the printer 20 in the same manner as with the ink cartridges 100 of the embodiments described previously. Detachment of the ink container 101e from the adapter 109e and installation of the ink container 101e in the adapter 109e may be carried out with the adaptor 109e left installed in the holder 65 of the printer 20; or carried out with the adaptor 109e detached from the holder 65 of the printer 20.

The ink container 101e is furnished with an ink delivery portion 102, a refilling hole 105, an outside air vent hole 106, and an ink containing chamber 107 comparable to those of the ink cartridge 100 depicted in FIG. 6. The adaptor 109e is furnished with a board 110e and a power supply unit 160. Nine terminals 111 comparable to those of the board 110e in Embodiment 1 are arranged on the front face of the board 110e. A controller 130e and a memory 140e are arranged on the back face of the board 110e.

The board 110 is additionally furnished with a photosensor 120e. The photosensor 120e is situated on the insertion space ISP side of the adaptor 109e. The photosensor 120e is used for detecting whether the ink container 101e is currently in the installed state, i.e. installed in the insertion space ISP of the adaptor 109e; or whether the ink container 101e is currently in the non-installed state, i.e. not installed in the insertion space ISP.

The memory 140e records liquid information that includes residual ink amount information comparable to that in Embodiment 1. With the adaptor 109e in the installed state, the memory 140e will be accessed by the printer 20 to read or write liquid information. The controller 130e operates when it receives power from the power supply unit 160. When detachment of the ink container 101e from the adaptor 109e (i.e. transition to the noninstalled state) has been detected by the photosensor 120e, the residual ink amount information recorded in the memory 140e will be rewritten to the initial value.

As will be understood from the preceding description, in the present embodiment, the photosensor 120e corresponds to the sensing portion in the claims. Also, in the present embodiment, the controller 130e corresponds to the information rewriting portion in the claims.

According to Modified Embodiment 11 described above, when the user detaches the ink container 101e from the adaptor 109e, the residual ink amount information will be reset to its initial value. Thus, when the user has refilled the detached ink container 101e with ink 5 and then reinstalled it in the adaptor 109e for example, the discrepancy between the residual ink amount information and the amount of ink 5 actually contained in the ink container 101e will be eliminated. As a result, misoperation of the printer 20 can be avoided, without the need for the user to perform any operation in order to reset the residual ink amount information to its initial value.

In the present embodiment, installation of the ink container 101e in the adaptor 109e may be detected by the photosensor 120e, and the controller 130e may then rewrite the residual ink amount information to the initial value when installation of the ink container 101e has been detected. Detection of installation of the ink container 101e from the adaptor 109e or detachment therefrom is not limited to being carried out by the photosensor 120e, and may instead by detected by the mechanical switch described earlier. Operations of the controller in the preceding embodiments and modified embodiments are also applicable to operations of the controller 130e in the present modified embodiment.

While the present invention has been shown herein in terms of certain preferred embodiments and modified embodiments, the present invention is not limited to these embodiments and their modifications, and may be embodied in various modes without departing from the spirit thereof.

While the liquid container pertaining to the invention have been shown and described on the basis of the embodiment and variation, the embodiments of the invention described herein are merely intended to facilitate understanding of the invention, and implies no limitation thereof. Various modifications and improvements of the invention are possible without departing from the spirit and scope thereof as recited in the appended claims, and these will naturally be included as equivalents in the invention.

1. A liquid container adapted for installation in a liquid jetting device, comprising:
a container body that contains a liquid;
a memory adapted to allow the liquid jetting device to read and write liquid information relating to the contained liquid while the liquid container is in an installed state installed in the liquid jetting device;
a sensing portion that detects installation of the liquid container in the liquid jetting device, or detachment of the liquid container from the liquid jetting device; and
an information rewriting portion that rewrites the liquid information in the memory, responsive to detection of the installation or detachment.

2. The liquid container in accordance with claim 1, wherein
the information rewriting portion rewrites the liquid information if a value of the liquid information in the memory meets a prescribed condition when the installation or detachment has been detected.

3. The liquid container in accordance with claim 1, wherein
the information rewriting portion rewrites the liquid information if an update count of the liquid information in the memory by the liquid jetting device exceeds a prescribed count when the installation or detachment has been detected.

4. The liquid container in accordance with claim 1, wherein
the liquid information includes liquid amount information for identifying at least either one of a consumed amount and a residual amount of the contained liquid.

5. The liquid container in accordance with claim 4, wherein
the liquid jetting device rewrites consumed amount information in the memory so as to increase the consumed amount of liquid indicated by the consumed amount information, and
the information rewriting portion rewrites the consumed amount information in the memory so as to decrease the consumed amount of liquid indicated by the consumed amount information.

6. The liquid container in accordance with claim 1, wherein
the liquid container is furnished with a refilling hole for refilling the liquid.

7. The liquid container in accordance with claim 1, further comprising:
a memory terminal adapted to provide electrical connection of the memory and the liquid jetting device in the installed state; and
a switching portion that switches a connection of the memory and the memory terminal between a state of continuity and a state of non-continuity;
wherein the switching portion places the connection of the memory and the memory terminal to a state of non-continuity while the information rewriting portion is rewriting the liquid information.

8. The liquid container in accordance with claim 1, further comprising:
a memory terminal adapted to provide electrical connection of the memory and the liquid jetting device in the installed state; and
a switching portion that switches a connection of the memory and the memory terminal between a state of continuity and a state of non-continuity;
wherein the switching portion places the connection of the memory and the memory terminal to a state of non-continuity during a time interval that includes an interval in which the information rewriting portion is rewriting the liquid information.

9. The liquid container in accordance with claim 1, wherein
the sensing portion includes a photosensor.

10. The liquid container in accordance with claim 1, wherein
the sensing portion includes a switch.

11. The liquid container in accordance with claim 1, further comprising:
a power supply unit that supplies power for enabling the information rewriting portion to read from or write to the memory, while the liquid container is not installed in the liquid jetting device.

12. A board mountable on a liquid container that contains the liquid and adapted for installation in a liquid jetting device, comprising:
a memory adapted to allow the liquid jetting device to read and write liquid information relating to a liquid for supply to the liquid jetting device when the board is in an installed state installed in the liquid jetting device;
a sensing portion that detects installation of the board on the liquid container, or detachment of the board from the liquid container; and
an information rewriting portion that rewrites the liquid information in the memory independently of the liquid jetting device, responsive to detection of the installation or detachment.

13. (canceled)

14. A method of rewriting liquid information recorded in a memory, wherein the information relates to a liquid that is contained in a liquid container and that is supplied to a liquid jetting device, comprising:
a first step of detecting installation of the liquid container in the liquid jetting device or detachment of the liquid container from the liquid jetting device; and
a second step of rewriting the liquid information in the memory independently of the liquid jetting device, responsive to detection of the installation or detachment.

15. A liquid container adapted for installation in a liquid jetting device, comprising:
a liquid container portion that contains a liquid; and
an adaptor adapted to receive detachable installation of the liquid container portion, and adapted to be installed in the liquid jetting device;
wherein the adaptor includes:
a memory adapted to allow the liquid jetting device to read and write liquid information relating to the liquid when the adaptor is in an installed state installed in the liquid jetting device;
a sensing portion that detects installation of the liquid container portion in the adaptor or detachment of the liquid container portion from the adaptor; and
an information rewriting portion that rewrites the liquid information in the memory, responsive to detection of the installation or detachment.
